(19) United States
(12) Patent Application Publication
(10) Pub. No.: US 2012/0001733 A1
(43) Pub. Date: Jan. 5, 2012

(54) INFORMATION PROCESSING APPARATUS, INFORMATION PROCESSING METHOD, AND PROGRAM

(75) Inventors: Satoshi Kousaka, Kanagawa (JP); Takashi Abeno, Kanagawa (JP)

(73) Assignee: SONY CORPORATION, Tokyo (JP)

(21) Appl. No.: 13/167,034

(22) Filed: Jun. 23, 2011

(30) Foreign Application Priority Data
Jun. 30, 2010 (JP) P2010-149366
May 19, 2011 (JP) P2011-112746

(51) Int. Cl. H04Q 5/22

(52) U.S. Cl. 340/10.1

(57) ABSTRACT

There is provided an information processing apparatus including a retrieval unit for obtaining an activator for preparing activation of a communication function of the information processing apparatus and a driver for activating the communication function of the information processing apparatus, an execution unit for executing the activator and the driver obtained by the retrieval unit, a storage unit for causing the execution unit to execute the activator and obtaining an activation key representing the communication function allowed to be activated in the information processing apparatus, and an activation unit for causing the execution unit to execute the driver and activating the communication function, allowed to be activated in the information processing apparatus, indicated by the activation key.

### BACKGROUND

The present disclosure relates to an information processing apparatus, an information processing method, and a program.

In recent years, wireless communication functions are implemented on many electronic devices, and accordingly, various wireless communication standards have been established. For example, various communication standards such as NFC (Near Field Communication), FALP (FeliCa Ad-hoc Link Protocol), and PC/SC (Personal Computer/Smart Card) are defined as short distance wireless communication standards.

The NFC is a communication method used by “FeliCa (registered trademark)” of Sony Corporation, which is widely used as a non-contact IC card. The FALP is a bidirectional data communication protocol using FeliCa techniques.

PC/SC (Personal Computer/Smart Card) is a specification of standard application interface to use an IC card in a computer environment such as Windows (registered trademark). This specification is based on ISO7816, i.e., an international standard, serving as a driver interface for a contact IC card reader/writer. Since it is compatible with the specifications of GSM and EMV, it is widely supported and serving as a de facto standard.

In these circumstances, for example, as disclosed in Japanese Patent Application Laid-Open No. 2010-021906, an information processing apparatus such as a PC (Personal Computer) has various communication devices supporting various communication standards which can be provided in the information processing apparatus or can be externally attached to the information processing apparatus. For example, the information processing apparatus has a reader/writer supporting NFC communication standard and a reader/writer supporting PC/SC communication standard, which can be provided in the information processing apparatus or can be externally attached to the information processing apparatus.

### SUMMARY

By the way, in the information processing apparatus, drivers for activating communication functions of the information processing apparatus support communication functions of various communication standards. Therefore, when a user executes a driver in the information processing apparatus, the communication functions of the various communication standards of the information processing apparatus are activated, and the user can use these functions.

In some cases, however, it may not be preferable to allow a user to use the communication functions of the various communication standards by executing the driver in the information processing apparatus. For example, there is an issue in that the user may be allowed to use applications and services that the user does not want to use.

In light of the foregoing, it is desirable to provide a novel and improved information processing apparatus, information processing method, and program, capable of limiting communication functions activated by execution of a driver.

According to an embodiment of the present invention, there is provided an information processing apparatus includes includes an activator retrieval unit for obtaining an activator for preparing activation of a communication function of the information processing apparatus, an activator execution unit for executing the activator obtained by the activator retrieval unit, an activation information retrieval unit for obtaining activation information representing a communication function allowed to be activated in the information processing apparatus in accordance with the activator execution unit executes the activator, a driver retrieval unit for obtaining a driver for activating the communication function of the information processing apparatus, a driver execution unit for executing the driver obtained by the driver retrieval unit, and an activation unit for activating the communication function allowed to be activated in the information processing apparatus indicated by the activation information in accordance with the driver execution unit executes the driver.

In this configuration, the activation information is an activation key. In this configuration, the activator retrieval unit obtains the activator when a password is authenticated.

In this configuration, activation unit activates the communication function when a password is authenticated.

In this configuration, the information processing apparatus further includes a setting unit for setting the activation key to a storage unit, the activation unit activates the communication function, allowed to be activated in the information processing apparatus, indicated by the activation key set in the storage unit.

In this configuration, the information processing apparatus according to claim 2, further includes a detection unit for detecting connection of a communication device to the information processing apparatus, and a communication device information retrieval unit, wherein when the detection unit detects connection of the communication device to the information processing apparatus, the communication device information retrieval unit obtains information about the communication device held in a storage unit of the communication device. The activator retrieval unit obtains the activator for preparing activation of the communication function of the communication standard of the communication device in the information processing apparatus, on the basis of the information about the communication device obtained by the communication device information retrieval unit.

In this configuration, the information processing apparatus further includes a communication standard determination unit for determining the communication standard of the communication device, on the basis of the information about the communication device obtained by the communication device information retrieval unit, a communication function activation determination unit for determining whether the communication function of the communication standard of the communication device determined by the communication standard determination unit is activated or not in the information processing apparatus, and a transmission unit, wherein when the communication function of the communication standard of the communication device is determined not to be activated in the information processing apparatus as a result of the determination made by the communication function activation determination unit, the transmission unit transmits, to a server, activation possibility determination information with which the server determines whether the communication function can be activated or not. The activator retrieval unit obtains the activator for preparing activation of the communication function of the communication standard of the communication device in the information processing apparatus, which is determined to be obtainable when the server determines that the communication function of the communication standard of the communication device in the information processing apparatus can be activated on the basis of the activation possibility determination information.

In this configuration, the activation possibility determination information includes one time password that is input from a communication medium communicating with the communication device.

In this configuration, the information processing apparatus, further includes a setting unit for setting the activation key to a storage unit, a reference unit for looking up the storage unit when the driver execution unit executes the driver, a setting determination unit for determining whether the activation key is set to the storage unit or not as a result of the look-up by the reference unit, and a validity determination unit, wherein when the activation key is determined to be set to the storage unit as a result of the determination made by the setting determination unit, the validity determination unit determines whether the activation key set in the storage unit is valid or not. When the activation key set in the storage unit is determined to be valid as a result of the determination made by the validity determination unit, the activation unit activates the communication function, allowed to be activated in the information processing apparatus, indicated by the activation key set in the storage unit.

In this configuration, the validity determination unit determines whether the activation key is valid or not on the basis of a one time password.

In this configuration, the transmission unit transmits, to the server, the activation possibility determination information attached with application unique information of application desired to be used by a user in the information processing apparatus, and the activator retrieval unit further obtains an activator for activating a function of the application from the server.

In this configuration, the transmission unit transmits, to the server, the activation possibility determination information attached with unique information of a card scanned over the communication device by a user, and the activator retrieval unit further obtains an activator for activating the communication function in unit of particular card from the server.

In this configuration, the transmission unit transmits, to the server, the activation possibility determination information attached with information about an individual identifier of the communication device, and the activator retrieval unit further obtains an activator for activating the communication function in unit of destination and individual product of particular communication device from the server.

In this configuration, the transmission unit transmits, to the server, the activation possibility determination information attached with time and date information, and the activator retrieval unit further obtains an activator for activating the communication function in unit of lot of particular communication device from the server.

In this configuration, the transmission unit transmits, to the server, the activation possibility determination information attached with information about I/F and information about internal/external type, and the activator retrieval unit further obtains an activator for activating the communication function in unit of I/F and type of particular communication device from the server.

In this configuration, the transmission unit transmits, to the server, the activation possibility determination information attached with information about vendor ID and product ID, and the activator retrieval unit further obtains an activator for activating the communication function in unit of product of particular communication device from the server. In this configuration, the password is a one time password.

According to another embodiment of the present invention, there is provided an information processing method includes obtaining an activator for preparing activation of a communication function of an information processing apparatus, executing the activator obtained by in the activator retrieval step, obtaining an activation key representing a communication function allowed to be activated in the information processing apparatus in accordance with the activator is executed in the activator execution step, obtaining a driver for activating the communication function of the information processing apparatus, executing the driver obtained in the driver retrieval step, and activating the communication function, allowed to be activated in the information processing apparatus, indicated by the activation key in accordance with the driver is executed in the driver execution step.

According to another embodiment of the present invention, there is provided a program for causing a computer to function as an activator retrieval unit for obtaining an activator for preparing activation of a communication function of an information processing apparatus, an activator execution unit for executing the activator obtained by the activator retrieval unit, an activation key retrieval unit for obtaining an activation key representing a communication function allowed to be activated in the information processing apparatus in accordance with the activator execution unit executes the activator, a driver retrieval unit for obtaining a driver for activating the communication function of the information processing apparatus, a driver execution unit for executing the driver obtained by the driver retrieval unit; and an activation unit for activating the communication function, allowed to be activated in the information processing apparatus, indicated by the activation key in accordance with the driver execution unit executes the driver.

As described above, according to the present disclosure, a communication function activated by execution of a driver can be limited.

### BRIEF DESCRIPTION OF THE DRAWINGS

FIG. 1 is an explanatory diagram schematically illustrating a configuration of an information processing system according to a first embodiment of the present disclosure;

FIG. 2 is a block diagram schematically illustrating a hardware configuration of the information processing apparatus shown in FIG. 1;

FIG. 3 is a block diagram schematically illustrating a functional configuration of the information processing apparatus shown in FIG. 1;

FIG. 4 is a schematic diagram illustrating service provision of the information processing system shown in FIG. 1;

FIG. 5 is an explanatory diagram illustrating a configuration of a driver shown in FIG. 4;

FIG. 6 is a flowchart illustrating activation preparation processing executed by the information processing apparatus shown in FIG. 1;

FIG. 7 is a flowchart illustrating activation processing executed by the information processing apparatus shown in FIG. 1;

FIG. 8 is an explanatory diagram schematically illustrating a configuration of an information processing system according to a second embodiment of the present disclosure and functional configurations of respective devices;

FIG. 9 is a sequence diagram illustrating activation processing executed by the information processing system shown in FIG. 8;

FIG. 10 is an explanatory diagram illustrating predetermined information attached to a portion of activation possibility determination information; and

FIG. 11 is a schematic diagram illustrating an example of determination as to whether activation can be made using one time password.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following explanation will be made in the order listed below.

1. Configuration of information processing system (first embodiment)

2. Hardware configuration of information processing apparatus

3. Functional configuration of information processing apparatus

4. Service provision of information processing system

5. Driver configuration

6. Activation preparation processing

7. Activation processing (first embodiment)

8. Configuration of information processing system and functional configuration of each device (second embodiment)

9. Activation processing (second embodiment)

### [1. Configuration of Information Processing System]

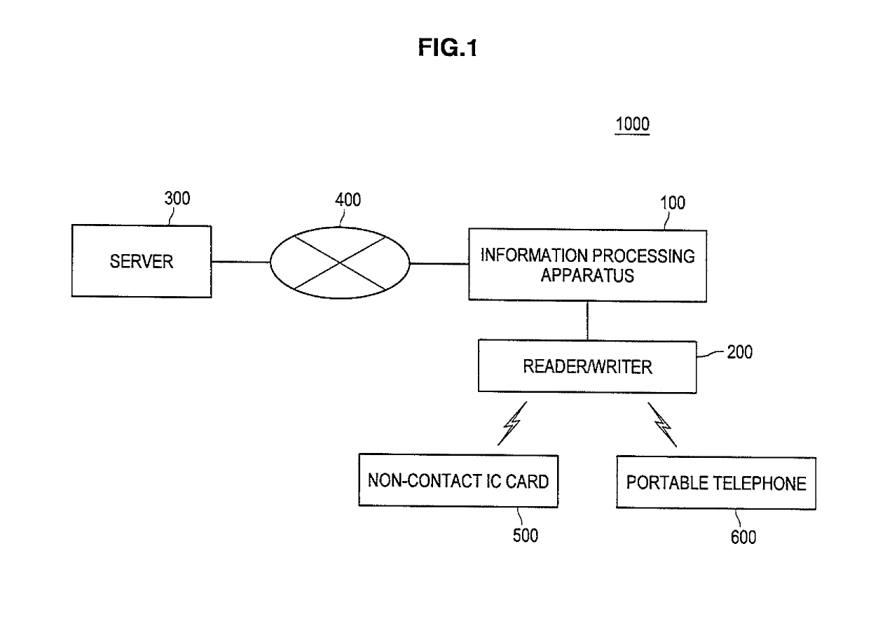

First, an information processing system according to the first embodiment of the present disclosure will be explained. FIG. 1 is an explanatory diagram schematically illustrating a configuration of an information processing system according to the embodiment.

In FIG. 1, an information processing system 1000 includes an information processing apparatus 100 such as a PC (Personal Computer), a reader/writer 200, and a server 300. The information processing apparatus 100 and the server 300 can communicate with each other via a network 400 such as the Internet. The reader/writer 200 is an example of communication device of the present disclosure. The reader/writer 200 can communicate with, for example, a non-contact IC card 500 and a portable telephone 600 having a non-contact IC card (not shown) incorporated therein in a non-contact style communication. The reader/writer 200 may be built into the information processing apparatus 100, or may be externally connected to the information processing apparatus 100.

When the information processing apparatus 100 includes, for example, a reader/writer supporting an NFC communication standard, or is connected to the external reader/writer, a user of the information processing apparatus 100 can use applications and services supporting the NFC communication standard by activating communication function of the NFC of the information processing apparatus 100.

The information processing apparatus 100 can obtain, from the server 300, software for preparing activation of communication function of various communication standards of the information processing apparatus 100 (hereinafter this software is referred to as “activator”). However, the method for obtaining the activator is not limited thereto. For example, the information processing apparatus 100 may obtain the activator via a removable recording medium 36 explained later.

The information processing apparatus 100 can obtain, from the server 300, software for activation of communication function of various communication standards of the information processing apparatus 100 (hereinafter this software is referred to as “driver”). However, the method for obtaining the driver is not limited thereto. For example, the information processing apparatus 100 may obtain the driver via the removable recording medium 36 explained later.

### [2. Hardware Configuration of Information Processing Apparatus]

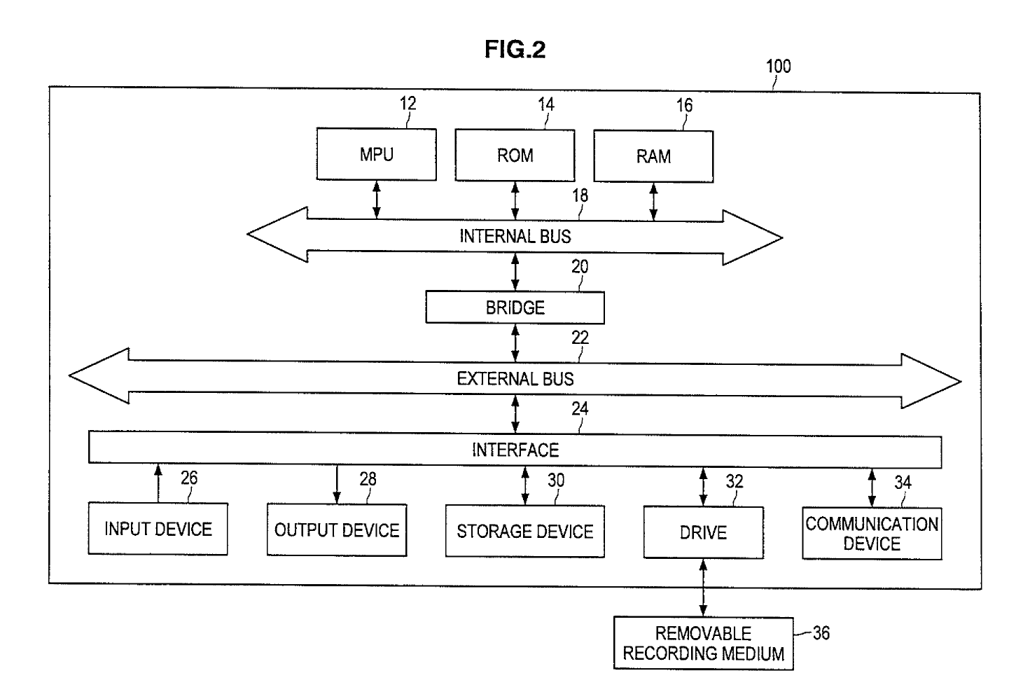

Subsequently, a hardware configuration of the information processing apparatus 100 shown in FIG. 1 will be explained. FIG. 2 is a block diagram schematically illustrating a hardware configuration of the information processing apparatus 100 shown in FIG. 1.

In FIG. 2, the information processing apparatus 100 includes an MPU (Micro Processing Unit) 12, a ROM (Read Only Memory) 14, a RAM (Random Access Memory) 16, and an internal bus 18. The information processing apparatus 100 includes a bridge 20, an external bus 22, an interface 24, an input device 26, an output device 28, a storage device (HDD) 30, a drive 32, and a communication device 34.

The MPU 12 functions as an arithmetic processing unit and a control unit and controls overall operations in the information processing apparatus 100 according to various programs. The ROM 14 stores programs and arithmetic parameters used by the MPU 12. The RAM 16 temporarily stores programs used for execution of the MPU 12 and parameters that appropriately change during execution thereof. These units are mutually connected via the internal bus 18 serving as a data transmission path.

The internal bus 18 is connected to the external bus 22 such as a PCI (Peripheral Component Interconnect/Interface) bus via the bridge 20. Incidentally, the internal bus 18, the bridge 20, and the external bus 22 may not be configured separately and these functions may be implemented in one bus.

The input device 26 is constituted of, for example, input means used by a user to input information such as a mouse, a keyboard, a touch panel, buttons, a microphone, switches, and levers, and an input control circuit that generates an input signal based on input by the user and outputs the input signal to the MPU 12. The user of the information processing apparatus 100 can input various kinds of data into or instruct processing operations to the information processing apparatus 100 by operating the input device 26.

The output device 28 includes, for example, a display device such as a CRT (Cathode Ray Tube) display device, liquid crystal display (LCD) device, OLED (Organic Light Emitting Diode) device, and lamps. On the other hand, the output device 28 includes an audio output device such as a speaker and headphone. The output device 28 outputs, for example, reproduced contents. More specifically, the display device displays various kinds of information such as reproduced video data as text or images. The audio output device converts reproduced audio data and the like into sound for outputting the sound.

The storage device 30 is a device for storing data. The storage device 30 may include a storage medium, a recording device to record data in the storage medium, a reading device to read data from the storage medium, and a deletion device to delete data recorded in the storage medium. The storage device 30 is constituted of, for example, an HDD (Hard Disk Drive). The storage device 30 drives the hard disk and stores programs executed by the MPU 12 and various kinds of data.

The drive 32 is a reader/writer for recording medium, which may be built into, or externally attached to, the information processing apparatus 100. The drive 32 reads information recorded in a loaded removable recording medium 36 such as a magnetic disk, an optical disk, a magneto-optical disk, and a semiconductor memory, and outputs the information to the RAM 16.

The communication device 34 is, for example, a communication interface constituted of a communication device and the like to connect to the network 400 and the reader/writer 200. The communication device 34 may be a wireless LAN (Local Area Network) compliant communication device, or may be a wired communication device that performs communication by wire.

### [3. Functional Configuration of Information Processing Apparatus]

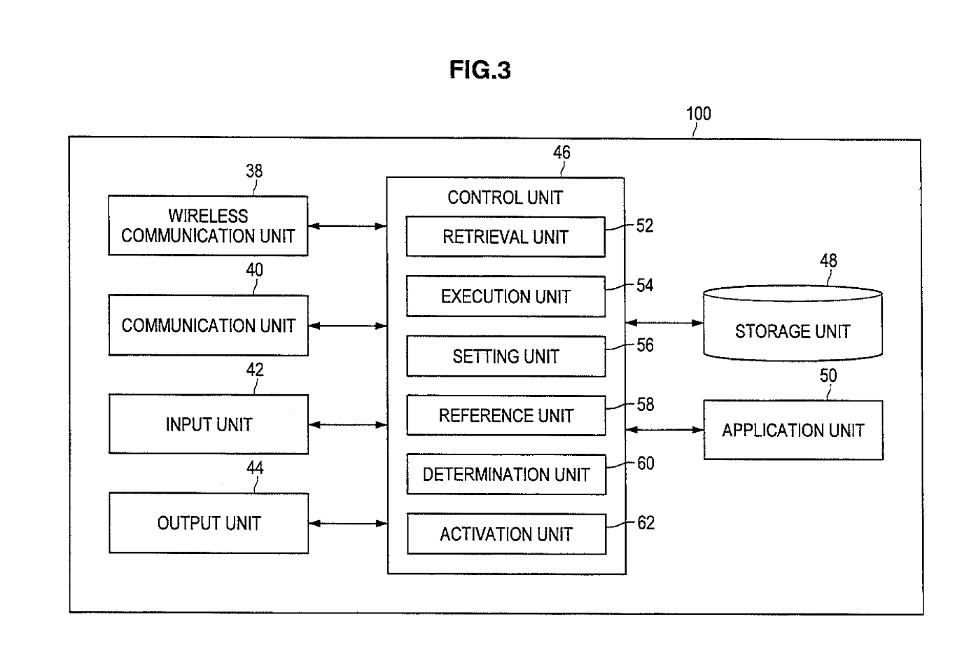

Subsequently, the functional configuration of the information processing apparatus 100 shown in FIG. 1 will be explained. FIG. 3 is a block diagram schematically illustrating a functional configuration of the information processing apparatus 100 shown in FIG. 1.

As shown in FIG. 3, the information processing apparatus 100 includes a wireless communication unit 38, a communication unit 40, an input unit 42, an output unit 44, a control unit 46, a storage unit 48, and an application unit 50. The control unit 46 includes a retrieval unit 52, an execution unit 54, a setting unit 56, a reference unit 58, a determination unit 60, and an activation unit 62.

The wireless communication unit 38 can communicate with, for example, a non-contact IC card 500 and a portable telephone 600 having a non-contact IC card (not shown) incorporated therein in a non-contact style communication.

The communication unit 40 can communicate with the reader/writer 200 attached externally to the information processing apparatus 100. The communication unit 40 can communicate with the server 300 via the network 400.

The input unit 42 receives operation and input from a user, and transmits an input signal based on the received operation and input to the control unit 46. The output unit 44 displays, as text or images, various kinds of information such as video data based on the output signal transmitted from the control unit 46, and coverts audio data into sound and outputs the sound.

The control unit 46 is connected to the wireless communication unit 38, the communication unit 40, the input unit 42, the output unit 44, the storage unit 48, and the application unit 50, and is configured to control the function of each constituent element.

The retrieval unit 52 serves as an example of activator retrieval unit, driver retrieval unit, communication device information retrieval unit according to the present disclosure, and obtains an activator and a driver from the server 300 or the removable recording medium 36. The execution unit 54 serves as an example of activator execution unit and driver execution unit according to the present disclosure, and is configured to execute the activator and the driver obtained by the retrieval unit 52.

When the execution unit 54 executes the activator, the setting unit 56 sets an activation key to a registry of the storage unit 48. The activation key indicates a communication function allowed to be activated in the information processing apparatus 100. When the execution unit executes the driver, the reference unit 58 looks up the registry of the storage unit 48.

The determination unit 60 serves as an example of setting determination unit and validity determination unit according to the present disclosure, and is configured to determine whether an activation key is set to the registry of the storage unit 48 on the basis of the registry looked up by the reference unit 58. When the activation key is set to the registry of the storage unit 48, the determination unit 60 determines whether the activation key set in the registry of the storage unit 48 is valid or not.

When the activation key set in the registry of the storage unit 48 is valid, the execution unit 54 executes the driver, whereby the activation unit 62 activates the communication function, allowed to be activated in the information processing apparatus 100, which is indicated by the activation key set in the registry of the storage unit 48.

In the storage unit 48, the activation key is set in the registry. The storage unit 48 functions as an activation key retrieval unit for obtaining an activation key. The application unit 50 provides applications and services to users.

For example, the wireless communication unit 38 corresponds to the communication device 34 shown in FIG. 2. For example, the communication unit 40 corresponds to the communication device 34 shown in FIG. 2. For example, the input unit 42 corresponds to the input device 26 shown in FIG. 2. For example, the output unit 44 corresponds to the output device 28 shown in FIG. 2. For example, the control unit 46 corresponds to the MPU 12 shown in FIG. 2. For example, the storage unit 48 corresponds to the RAM 16 and the storage device 30 shown in FIG. 2. For example, the application unit 50 corresponds to the MPU 12 and the storage device 30 shown in FIG. 2.

### [4. Service Provision of Information Processing System]

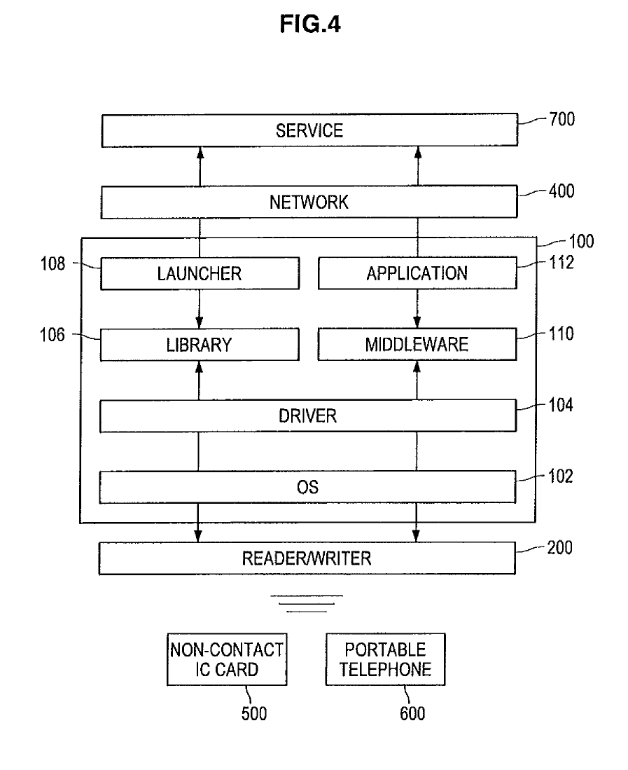

Subsequently, service provision of the information processing system 1000 shown in FIG. 1 will be explained. FIG. 4 is a schematic diagram illustrating service provision of the information processing system 1000 shown in FIG. 1.

In FIG. 4, the information processing apparatus 100 includes an OS (Operating System) 102, a driver 104, a library 106, a launcher 108, a middleware 110, and an application 112.

The OS 102 is capable of transmitting and receiving data to/from the reader/writer 200. For example, the OS 102 is capable of transmitting and receiving data to/from a service 700 serving as a service provision server, which is connected to the network 400 via the driver 104, the library 106, and the launcher 108. Further, the OS 102 is capable of transmitting and receiving data to/from the service 700 connected to the network 400 via the driver 104, the middleware 110, and the application 112.

In the information processing system 1000, the OS 102 transmits and receives data to/from the reader/writer 200, and the OS 102 transmits and receives data to/from the service 700, so that the user of the information processing apparatus 100 can use the service provided by the service 700.

### [5. Driver Configuration]

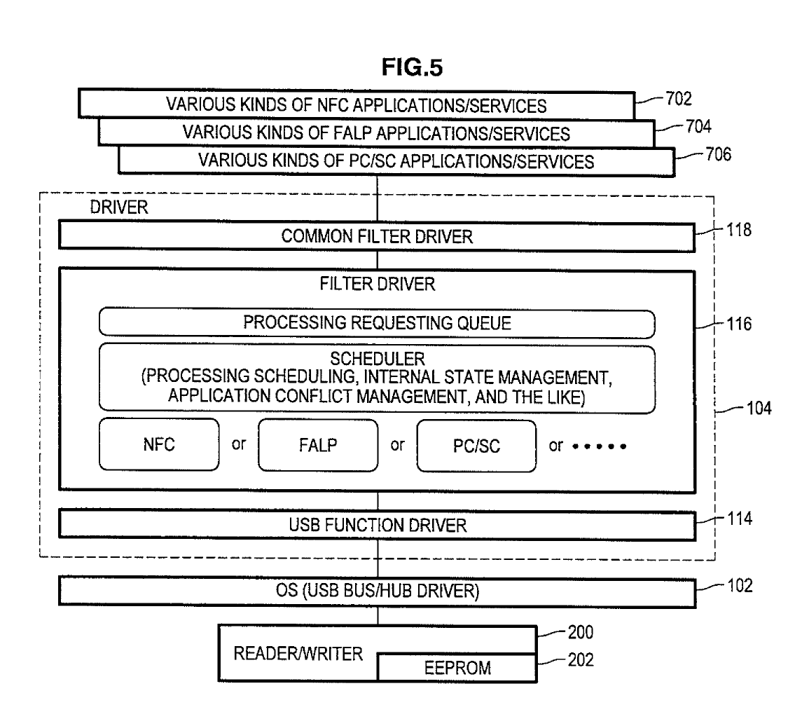

Subsequently, the configuration of the driver 104 shown in FIG. 4 will be explained. FIG. 5 is an explanatory diagram illustrating a configuration of the driver 104 shown in FIG. 4.

In FIG. 5, the driver 104 includes a USB function driver 114, a filter driver 116, and a common filter driver 118.

The USB function driver 114 functions as a communication processing unit for receiving data. The filter driver 116 functions as a data processing unit for processing data to be transmitted and received and a communication control unit for controlling transmission/reception of data. The common filter driver 118 functions as a device management unit for managing individual reader/writers 200.

Further, as shown in FIG. 5, the reader/writer 200 has an EEPROM (Electrically Erasable and Programmable Read Only Memory) 202 storing information such as an individual identifier of the reader/writer 200, explained later.

The service 700 shown in FIG. 4 includes various kinds of NFC applications/services 702, various kinds of FALP applications/services 704, and various kinds of PC/SC applications/services 706 as shown in FIG. 5.

### [6. Activation Preparation Processing]

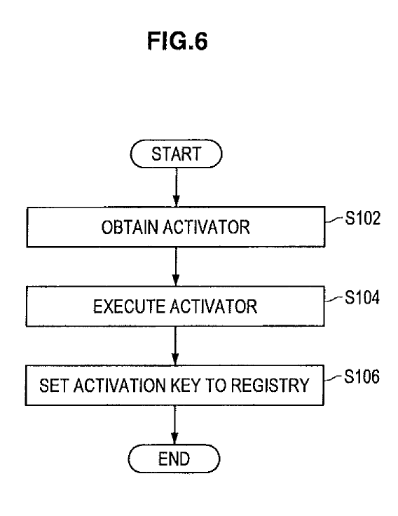

Subsequently, the activation preparation processing executed by the information processing apparatus 100 shown in FIG. 1 will be explained. FIG. 6 is a flowchart illustrating activation preparation processing executed by the information processing apparatus 100 shown in FIG. 1.

In FIG. 6, first, the retrieval unit 52 of the information processing apparatus 100 obtains, for example, an activator for preparation of activation of a communication function of various communication standards for the information processing apparatus 100 from the server 300 via the network 400 (step S102).

Subsequently, the execution unit 54 of the information processing apparatus 100 executes the activator obtained in step S102 (step S104).

Subsequently, in response to the execution of the activator in step S104, the setting unit 56 of the information processing apparatus 100 sets an activation key to the registry of the storage unit 48 (step S106), and terminates this processing. The activation key indicates a communication function allowed to be activated in the information processing apparatus 100.

According to the activation preparation processing of FIG. 6, when the information processing apparatus 100 executes the activator, the activation key indicating the communication function allowed to be activated in the information processing apparatus 100 is set to the registry of the storage unit 48.

### [7. Activation Processing]

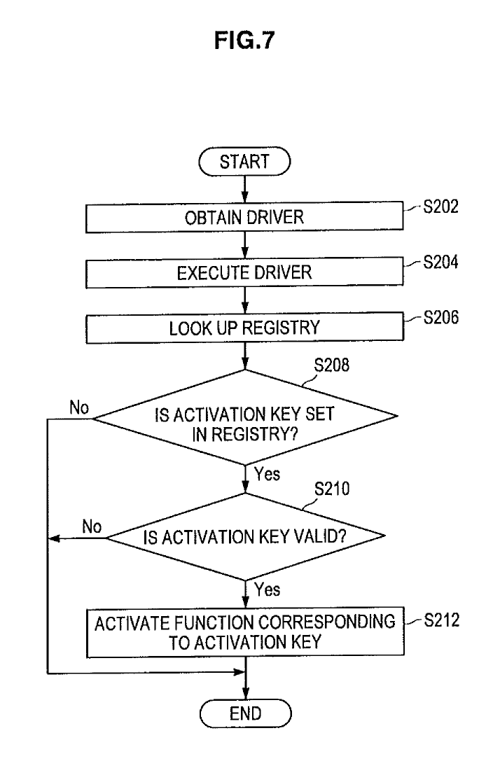

Subsequently, the activation processing executed by the information processing apparatus 100 shown in FIG. 1 will be explained. FIG. 7 is a flowchart illustrating activation processing executed by the information processing apparatus 100 shown in FIG. 1.

In FIG. 7, first, the retrieval unit 52 of the information processing apparatus 100 obtains, for example, a driver for activation of a communication function of various communication standards for the information processing apparatus 100 from the server 300 via the network 400 (step S202).

Subsequently, the execution unit 54 of the information processing apparatus 100 executes the driver obtained in step S202 (step S204).

Subsequently, when the driver is executed in step S204, the reference unit 58 of the information processing apparatus 100 looks up the registry of the storage unit 48 (step S206).

Subsequently, as a result of lookup of the registry in step S206, the determination unit 60 of the information processing apparatus 100 determines whether the activation key is set to the registry of the storage unit 48 (step S208).

When the activation key is determined not to be set to the registry of the storage unit 48 as a result of the determination made in step S208 (NO in step S208), the activator is not executed in the information processing apparatus 100, and accordingly, this processing is terminated as it is.

When the activation key is determined to be set to the registry of the storage unit 48 as a result of the determination made in step S208 (YES in step S208), the determination unit 60 of the information processing apparatus 100 determines whether the activation key set in the registry of the storage unit 48 is valid or not (step S210).

As further detailed below, when one time password is transmitted when the non-contact IC card 500 is scanned, a determination can be made as to whether an activation key is valid or not based on the one time password in the determination of step S210. In this case, when the non-contact IC 500 is scanned, the wireless communication unit obtains one time password. The information processing apparatus 100 obtains information about validity of the one time password via the network 400 from the communication unit 40. Therefore, when the one time password is determined to be valid, the determination unit 60 can determine that the activation key is valid.

When the activation key set in the registry of the storage unit 48 is determined not to be valid as a result of the determination made in step S210 (NO in step S210), invalid activation key is set to the registry of the storage unit 48, and accordingly, this processing is terminated as it is.

When the activation key set in the registry of the storage unit 48 is determined to be valid as a result of the determination made in step S210 (YES in step S210), the activation unit 62 of the information processing apparatus 100 activates the communication function, allowed to be activated in the information processing apparatus 100, which is indicated by the activation key set in the registry of the storage unit 48 (step S212), and this processing is terminated.

According to the activation processing of FIG. 7, when a valid activation key is set to the registry of the storage unit 48, and the driver is executed, the communication function, allowed to be activated in the information processing apparatus 100, which is indicated by the activation key is activated. Therefore, when the driver is executed in the information processing apparatus 100, the communication functions of various communication standards provided in the information processing apparatus 100 are not activated, and this limits the communication function activated by the execution of the driver.

Furthermore, according to the present embodiment, when an invalid activation key is set to the registry of the storage unit 48, the communication function of the information processing apparatus 100 is not activated, and this prevents invalid activation of the communication function in the information processing apparatus 100.

### [8. Configuration of Information Processing System and Functional Configuration of Each Device]

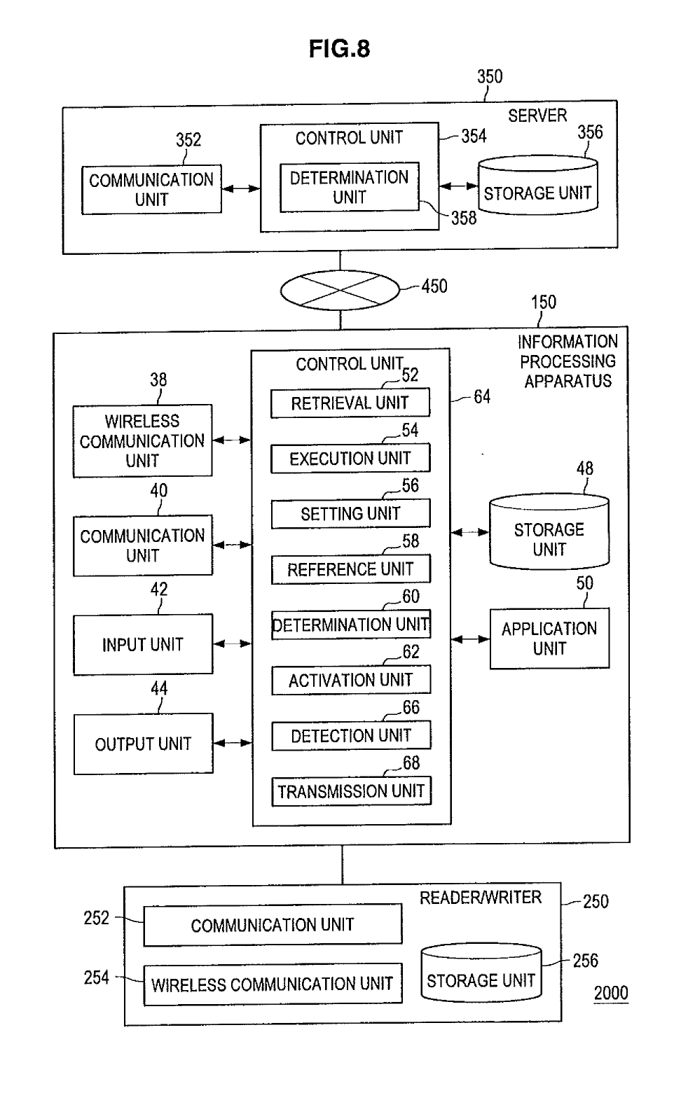

Subsequently, a configuration of an information processing system according to the second embodiment of the present disclosure and functional configurations of respective devices will be explained. FIG. 8 is an explanatory diagram schematically illustrating a configuration of an information processing system according to the present embodiment and functions of respective devices.

In FIG. 8, an information processing system 2000 includes an information processing apparatus 150 such as a PC, a reader/writer 250, and a server 350. The information processing apparatus 150 and the server 350 can communicate with each other via a network 450 such as the Internet. The reader/writer 250 can communicate with, for example, a non-contact IC card (not shown) and a portable telephone (not shown) having a non-contact IC card (not shown) incorporated therein in a non-contact style communication. The reader/writer 250 may be built into the information processing apparatus 150, or may be externally connected to the information processing apparatus 150.

When the information processing apparatus 150 includes, for example, a reader/writer supporting an NFC communication standard, or is connected to the external reader/writer, a user of the information processing apparatus 150 can use applications and services supporting the NFC communication standard by activating communication function of the NFC of the information processing apparatus 150.

The information processing apparatus 150 can obtain, from the server 350, an activator for preparing activation of communication function of various communication standards of the information processing apparatus 150. However, the method for obtaining the activator is not limited thereto. For example, the information processing apparatus 150 may obtain the activator via a removable recording medium (not shown).

The information processing apparatus 150 can obtain, from the server 350, driver for activation of communication function of various communication standards of the information processing apparatus 150. However, the method for obtaining the driver is not limited thereto. For example, the information processing apparatus 150 may obtain the driver via the removable recording medium (not shown).

The information processing apparatus 150 includes a wireless communication unit 38, a communication unit 40, an input unit 42, an output unit 44, a control unit 64, a storage unit 48, and an application unit 50. The control unit 64 includes a retrieval unit 52, an execution unit 54, a setting unit 56, a reference unit 58, a determination unit 60, an activation unit 62, a detection unit 66, and a transmission unit 68.

The wireless communication unit 38 can communicate with, for example, a non-contact IC card (not shown) and a portable telephone (not shown) having a non-contact IC card (not shown) incorporated therein in a non-contact style communication.

The communication unit 40 can communicate with the reader/writer 250 attached externally to the information processing apparatus 150. The communication unit 40 can communicate with the server 350 via the network 450.

The input unit 42 receives operation and input from a user, and transmits an input signal based on the received operation and input to the control unit 64. The output unit 44 displays, as text or images, various kinds of information such as video data based on the output signal transmitted from the control unit 64, and coverts audio data into sound and outputs the sound.

The control unit 64 is connected to the wireless communication unit 38, the communication unit 40, the input unit 42, the output unit 44, the storage unit 48, and the application unit 50, and is configured to control the function of each constituent element.

The retrieval unit 52 obtains an activator and a driver from the server 350 or a removable recording medium (not shown). The retrieval unit 52 also obtains information about the reader/writer 250 such as the individual identifier of the reader/writer 250 from the EEPROM (not shown) of the storage unit 256 of the reader/writer 250. The execution unit executes the activator and the driver obtained by the retrieval unit 52.

When the execution unit 54 executes the activator, the setting unit 56 sets an activation key to a registry of the storage unit 48. The activation key indicates a communication function allowed to be activated in the information processing apparatus 150. When the execution unit executes the driver, the reference unit 58 looks up the registry of the storage unit 48.

The determination unit 60 serves as an example of communication standard determination unit and communication function activation determination unit according to the present disclosure, and is configured to determine whether an activation key is set to the registry of the storage unit 48 on the basis of the registry looked up by the reference unit 58. When the activation key is set to the registry of the storage unit 48, the determination unit 60 determines whether the activation key set in the registry of the storage unit 48 is valid or not. The determination unit 60 determines the communication standard of the reader/writer 250 connected to the information processing apparatus 150 on the basis of information about the reader/writer 250 such as the individual identifier of the reader/writer 250 obtained by the retrieval unit 52. The determination unit 60 determines whether the communication function of the communication standard of the reader/writer 250 determined in the information processing apparatus 150 is activated or not.

When the activation key set in the registry of the storage unit 48 is valid, the execution unit 54 executes the driver, whereby the activation unit 62 activates the communication function, allowed to be activated in the information processing apparatus 150, which is indicated by the activation key set in the registry of the storage unit 48.

The detection unit 66 detects connection of the reader/writer 250 to the information processing apparatus 150. When the communication function of the communication standard of the reader/writer 250 in the information processing apparatus 150 is determined not to be activated as a result of the determination made by the determination unit 60, the transmission unit 68 transmits the activation possibility determination information to the server 350 via the network 450 in order to determine whether the communication function can be activated or not.

In the storage unit 48, the activation key is set in the registry. The storage unit 48 functions as an activation key retrieval unit for obtaining an activation key. The application unit 50 provides applications and services to users.

The reader/writer 250 includes a communication unit 252, a wireless communication unit 254, and a storage unit 256.

The communication unit 252 can communicate with the information processing apparatus 150. The wireless communication unit 254 can communicate with, for example, a non-contact IC card (not shown) and a portable telephone (not shown) having a non-contact IC card (not shown) incorporated therein in a non-contact style communication. The storage unit 256 includes an EEPROM (not shown), and the EEPROM stores information about the identifier of the reader/writer 250 and the like.

The server 350 includes a communication unit 352, a control unit 354, and a storage unit 356. The control unit 354 includes a determination unit 358.

The communication unit 352 can communicate with the information processing apparatus 150 via the network 450. The control unit 354 is connected to the communication unit 352 and the storage unit 356, and is configured to control the function of each constituent element. The determination unit 358 determines whether the communication function of the communication standard of the reader/writer 250 in the information processing apparatus 150 can be activated or not on the basis of the activation possibility determination information transmitted from the transmission unit 68 of the information processing apparatus 150. When the communication function can be activated as a result of the determination, the determination unit 358 enables the information processing apparatus 150 to obtain the activator from the server 350 in order to prepare activation of the communication function. The storage unit 356 stores the activators and the drivers.

### [9. Activation Processing]

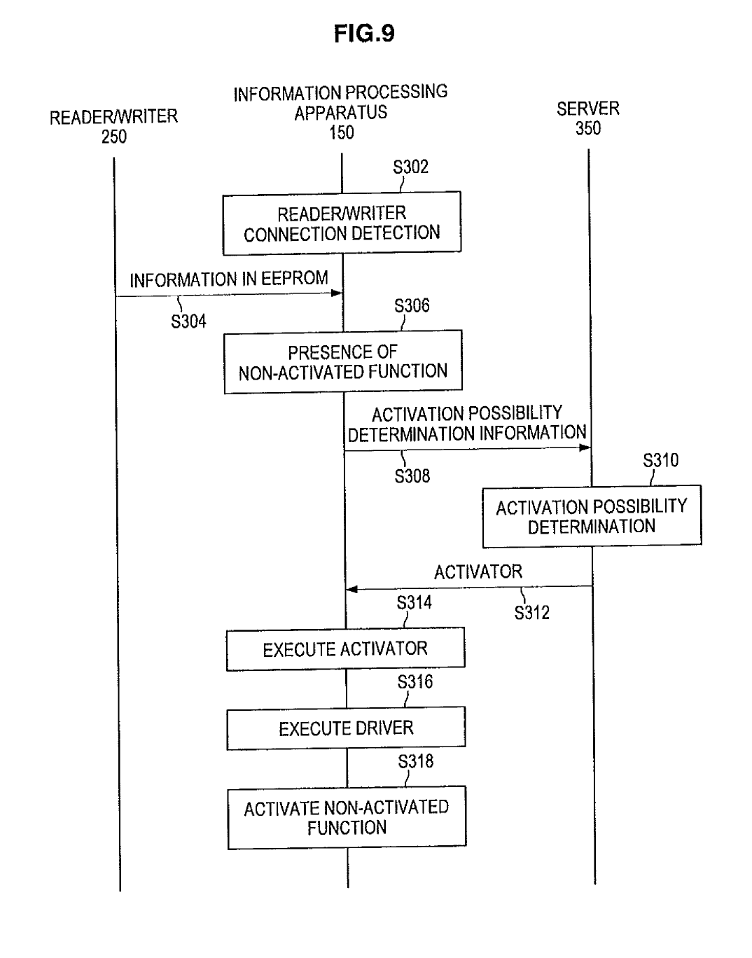

Subsequently, the activation processing executed by the information processing system 2000 shown in FIG. 8 will be explained. FIG. 9 is a sequence diagram illustrating activation processing executed by the information processing system 2000 shown in FIG. 8.

As shown in FIG. 9, first, when the detection unit of the information processing apparatus 150 detects connection of the reader/writer 250 to the information processing apparatus 150 (step S302), the retrieval unit 52 of the information processing apparatus 150 obtains information such as the individual identifier of the reader/writer 250 from an EEPROM (not shown) of the storage unit 256 of the reader/writer 250 (step S304).

Subsequently, the determination unit 60 of the information processing apparatus 150 determines the communication standard of the reader/writer 250 connected to the information processing apparatus 150, on the basis of the information about the reader/writer 250 such as the individual identifier of the reader/writer 250 obtained by the retrieval unit 52. Then, the determination unit 60 of the information processing apparatus 150 determines whether the communication function of the communication standard of the reader/writer 250 determined in the information processing apparatus 150 is activated or not. When the communication function of the communication standard of the reader/writer 250 in the information processing apparatus 150 is determined not to be activated as a result of the determination, i.e., when there is non-activated function (step S306), the transmission unit of the information processing apparatus 150 transmits the activation possibility determination information to the server 350 via the network 450 in order to determine whether the communication function can be activated or not (step S308).

Subsequently, the determination unit 358 of the server 350 determines whether the communication function of the communication standard of the reader/writer 250 in the information processing apparatus 150 can be activated or not on the basis of the activation possibility determination information transmitted from the transmission unit 68 of the information processing apparatus 150 (step S310). When the communication function can be activated as a result of the determination, the determination unit 358 of the server 350 enables the information processing apparatus 150 to obtain the activator from the server 350 in order to prepare activation of the communication function.

Subsequently, the retrieval unit 52 of the information processing apparatus 150 obtains an activator for preparation of activation of the communication function of the communication standard of the reader/writer 250 in the information processing apparatus 150 from the server 350 via the network 450 (step S312).

Subsequently, the execution unit 54 of the information processing apparatus 150 executes the activator obtained in step S312 (step S314). As a result, the activation key is set to the registry of the storage unit 48. The activation key represents the communication function of the communication standard of the reader/writer 250 serving as the communication function allowed to be activated in the information processing apparatus 150.

Subsequently, the execution unit 54 of the information processing apparatus 150 executes the obtained driver or a new driver obtained from the server 350 via the network 450 (step S316). Accordingly, the activation unit 62 of the information processing apparatus 150 activates the communication function of the communication standard of the reader/writer 250 serving as the communication function allowed to be activated in the information processing apparatus 150 indicated by the activation key set in the registry of the storage unit 48. In other words, the activation unit 62 activates the non-activated function (step S318), and terminates this processing.

According to the activation processing shown in FIG. 9, when the communication function of the communication standard of the reader/writer 250 connected in the information processing apparatus 150 is not activated, and the communication function can be activated, the information processing apparatus 150 obtains an activator for preparing activation of the communication function. Therefore, even when the reader/writer 250 having the communication standard in which the communication function is not activated is connected in the information processing apparatus 150, it is not necessary for the user himself/herself to obtain the activator for preparing activation of the communication function in the information processing apparatus 150 by operating the information processing apparatus 150, and therefore, this improves the ease of use of the information processing apparatus 150 by the user.

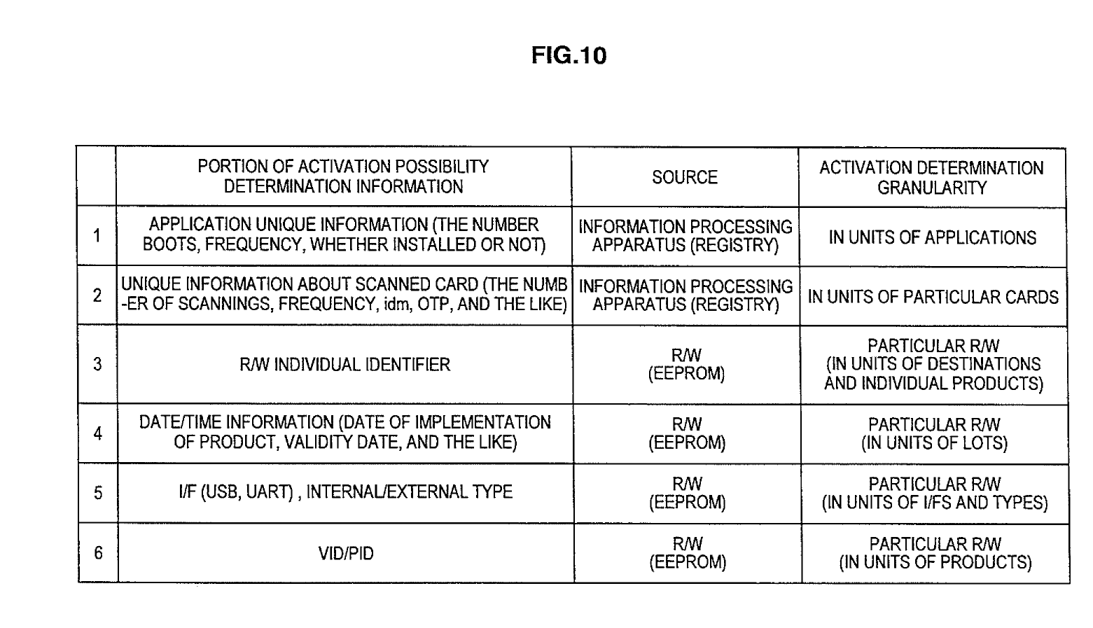

In the present embodiment, the information processing apparatus 150 transmits the activation possibility determination information to the server 350 in order to determine whether the communication function of the communication standard of the reader/writer 250, i.e., the non-activated function, can be activated or not, and the server 350 determines whether the communication function of the communication standard of the reader/writer 250 in the information processing apparatus 150 can be activated or not. Alternatively, as shown in FIG. 10, predetermined information may be added to a portion of the activation possibility determination information, so that the server 350 can determine whether the non-activated function of the information processing apparatus 150 can be activated or not.

For example, as shown in FIG. 10, application unique information desired to be used by the information processing apparatus 150 such as information about the number of boots, frequency, whether installed or not, and the like may be added to a portion of the activation possibility determination information, so that the server 350 can determine whether the application function can be activated or not in units of applications in the information processing apparatus 150. Then, the information processing apparatus 150 obtains the activator and the driver from the server 350 in order to activate the application function, thus capable of activating the application function.

For example, as shown in FIG. 10, unique information of a card scanned over the reader/writer 250 by the user such as information about the number of scannings, frequency, idm, one time password (OTP) may be added to a portion of the activation possibility determination information, so that the server 350 can determine whether the communication function can be activated or not in units of particular cards. Then, the information processing apparatus 150 obtains the activator and the driver from the server 350 in order to activate the communication function in units of particular cards, thus capable of activating the communication function in units of particular cards.

For example, as shown in FIG. 10, information about reader/writer (R/W) individual identifier may be added to a portion of the activation possibility determination information, so that the server 350 can determine whether the communication function can be activated or not in units of destinations and individual products of particular R/Ws. Then, the information processing apparatus 150 obtains the activator and the driver from the server 350 in order to activate the communication function in units of destinations and individual products of particular R/Ws, thus capable of activating the communication function in units of destinations and individual products of particular R/Ws.

For example, as shown in FIG. 10, date/time information such as information about date of implementation of product and validity date may be added to a portion of the activation possibility determination information, so that the server 350 can determine whether the communication function can be activated or not in units of lots of particular R/Ws. Then, the information processing apparatus 150 obtains the activator and the driver from the server 350 in order to activate the communication function in units of lots of particular R/Ws, thus capable of activating the communication function in units of lots of particular R/Ws.

For example, as shown in FIG. 10, information about I/F (USB, UART) and information about internal/external type may be added to a portion of the activation possibility determination information, so that the server 350 can determine whether the communication function can be activated or not in units of I/Fs and types of particular R/Ws. Then, the information processing apparatus 150 obtains the activator and the driver from the server 350 in order to activate the communication function in units of I/Fs and types of particular R/Ws, thus capable of activating the communication function in units of I/Fs and types of particular R/Ws.

For example, as shown in FIG. 10, information about VID (vendor ID) and PID (product ID) may be added to a portion of the activation possibility determination information, so that the server 350 can determine whether the communication function can be activated or not in units of products of particular R/Ws. Then, the information processing apparatus 150 obtains the activator and the driver from the server 350 in order to activate the communication function in units of products of particular R/Ws, thus capable of activating the communication function in units of products of particular R/Ws.

### [10. Determination as to Whether Activation can be Made Using One Time Password]

Subsequently, activation using one time password will be explained. As shown in FIG. 10, information about one time password given when a user scans the card over the reader/writer 250 may be added to a portion of the activation possibility determination information, so that the server 350 can determine whether the communication function can be activated or not in units of particular cards. The determination as to whether activation can be made using one time password or not will be hereinafter explained.

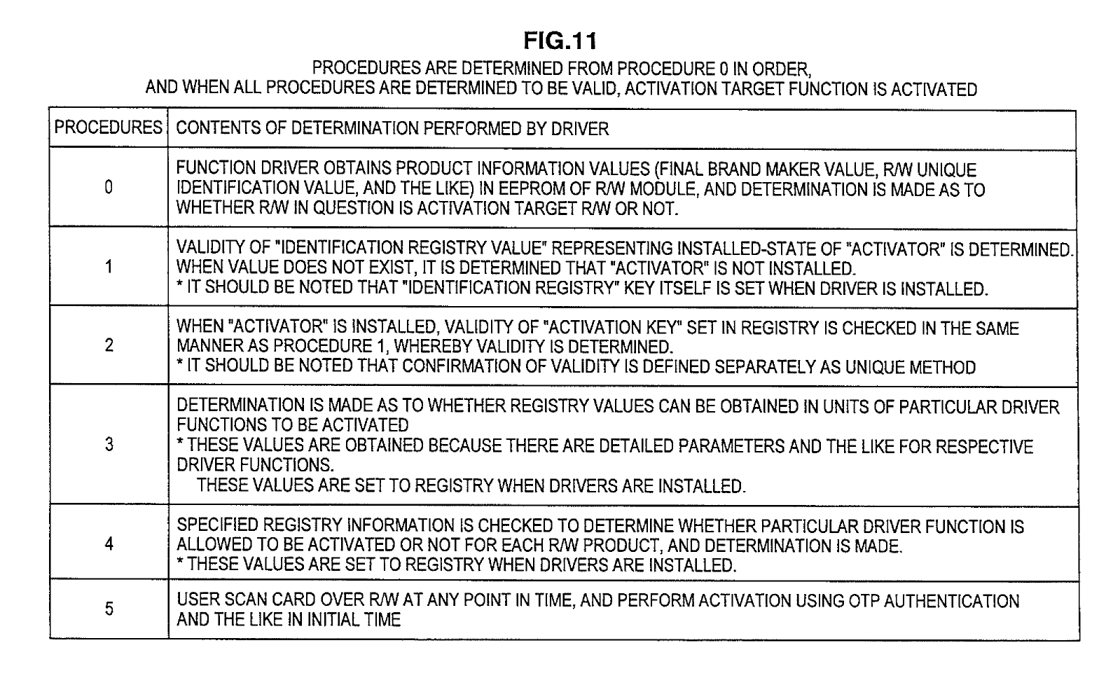

For example, one time password is a password used only once that is set every time the non-contact IC card 500 is canned over the reader/writer 200. FIG. 11 is a schematic diagram illustrating an example of determination as to whether activation can be made using one time password. When one time password is used, procedures 0 to 5 shown in FIG. 11 are determined in order. When all the procedures are valid, an activation target function is activated. The procedures 0 to 4 correspond to the above embodiments. When all the procedures 0 to 4 are valid, a user scans a card in the procedure 5 at any point in time, and in the initial time, activation is performed by OTP authentication and the like.

The operation will be explained more specifically. When the non-contact IC card 500 is scanned over the reader/writer 200 for the first time, this is detected by FeliCa launcher, and the screen is changed to an initial time-only Web page. An example of a Web page includes a portal site. Subsequently, the user of the non-contact IC card 500 is requested to input one time password, and a value of one time password of the non-contact IC card 500 set in the non-contact IC card 500 is transmitted to the server 350, and the server 350 authenticates the one time password.

The one time password set in the non-contact IC card 500 may be a visible one that can be recognized from the outside, or may be one that may not be recognized from the outside.

Subsequently, the server 350 determines whether activation can be made or not on the basis of the one time password. The server 350 obtains information about the one time password via another path in advance. The server 350 can determine whether activation can be made or not by comparing the one time password transmitted via the reader/writer 200 and the information processing apparatus 100 from the non-contact IC card 500 with the one time password obtained in advance. When the Web page is a portal site, a user usually inputs an ID and a password to proceed to a private page customized for the user. However, when one time password is used, access to the portal site can be activated without using any ID or password. Therefore, when a plurality of portal sites are used, it is not necessary for a user to remember an ID and a password for each portal site, and the user can easily access the portal sites. More specifically, both of an application of one time password and the server 350 set a shared private key as an initial value in advance, and mathematical algorithm such as a cryptographic hash function is used to generate a new password from a password that was previously output. The server 350 determines whether activation can be made by determining the validity (consistency) of the password. Alternatively, both of an application of one time password and the server 350 may perform time synchronization (looks up a common standard time providing server with each other) in advance, based on which a password is generated using common mathematic algorithm, whereby the server 350 can confirm the validity.

At this occasion, the activation target function can be activated based on the one time password as well as the determinations in the procedures 0 to 4 shown in FIG. 11, and the activation target function can be activated based on product information value (VID/PID, individual identification value, and the like) retrieved from the EEPROM of the storage unit 256 of the reader/writer 200 by the driver when the device is connected and based on registry storage information (date/time information, installed application information, booting frequency). On the other hand, it may be possible to determine whether activation can be made or not on the basis of only the one time password.

Subsequently, when the determination result of the one time password by the server 350 indicates that “activation can be made”, an activator is downloaded to the information processing apparatus 100, i.e., target PC, and activation is performed. The automatic activation can be turned on and off by a user with a UI program. In the configuration of the driver 104 shown in FIG. 5, when the function for enabling access of the non-contact IC card 500 is not activated, this function is activated in advance in order to perform authentication using one time password. Alternatively, it is preferable to use the driver 104 originally having a function for enabling access of the non-contact IC card 500.

When one time password is used in the second embodiment described above, and the non-contact IC card 500 is scanned over the reader/writer 250, the reader/writer 250 obtains the one time password from the non-contact IC card 500, and transmits the one time password and the information in the EEPROM to the information processing apparatus 150 in step S304 shown in FIG. 9. In step S308 of FIG. 9, the information processing apparatus 150 transmits the one time password, as a portion of the activation possibility information, to the server 350.

In step S310 shown in FIG. 9, the server 350 determines whether the communication function of the communication standard of the reader/writer 250 can be activated or not on the basis of the activation possibility determination information including the one time password. The processings subsequent thereto are the same as those of the second embodiment shown in FIG. 9. Therefore, only when the one time password is determined to be valid by the server 350, the information processing apparatus 150 can obtain the activator from the server 350 in order to prepare activation of the communication function. Then, when the driver is executed, the communication function indicated by the activation key can be activated.

When one time password is used in the first embodiment described above, the first embodiment may be configured as follows. Unless one time password is authenticated by the server 300 in step S102 of FIG. 6, the server 300 is configured not to transmit the activator. In step S210 shown in FIG. 7, determination can be made as to whether the activation key is valid or not on the basis of the one time password input from the reader/writer 200.

As described above, the activator is automatically downloaded on the basis of the one time password, so that this eliminates the necessity of distribution of the activator, and the processing can be simplified. Moreover, since one time password is a password that is set only once, the one time password is not compromised, and this can solve the security issue expected when a token having a fixed password is used. In addition, the user can activate the driver function only by scanning the non-contact IC card 500 over the reader/writer 200 at any point of time. Therefore, this can be used as a connection interface (I/F) to a system that is expected to rapidly expand in the future, such as a cloud network requiring security.

Further, the user of the non-contact IC card 500 having one time password set therein can activate a function only by scanning the non-contact IC card 500 over the reader/writer 200 without thinking of turning ON/OFF a driver function.

An object of the present disclosure as described above may also be achieved by providing a storage medium storing a program code of software achieving the functions of the above embodiments to a system or an apparatus and causing a computer (or a CPU, an MPU, or the like) of the system or the apparatus to read and execute the program code stored in the storage medium.

In this case, the program code itself read from the storage medium achieves the functions of the above embodiments. Therefore, the program code and the storage medium storing the program code constitute the present disclosure.

Examples of storage media providing the program code include a floppy (registered trademark) disk, a hard disk, an optical disk such as a magneto-optical disk, a CD-ROM, a CD-R, a CD-RW, a DVD-ROM, a DVD-RAM, a DVD-RW, and a DVD+RW, a magnetic tape, a non-volatile memory card, and a ROM. Alternatively, the program code may be downloaded via a network.

The functions of the above embodiments are achieved by executing the program code read by the computer. Furthermore, it is also achieved by causing an OS (operating system) running on the computer to perform a part or all of actual processings on the basis of commands given by the program code. It is to be understood that the functions of the above embodiments achieved by those processings are also included within the present disclosure.

Still further, the program code read from the storage medium may be written to a memory provided in a function expansion unit connected to the computer or a function expansion board inserted into the computer, and thereafter, a part or all of actual processings of the expanded functions may be performed by the expansion board, a CPU provided in the expansion unit, and the like, on the basis of the commands given by the program code. It is to be understood that the functions of the above embodiments achieved by those processings are also included within the present disclosure.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2010-149366 filed in the Japan Patent Office on Jun. 30, 2010 and Japanese Priority Patent Application JP 2011-112746 filed in the Japan Patent Office on May 19, 2011, the entire content of which is hereby incorporated by reference.

What is claimed is:

1. An information processing apparatus comprising:
an activator retrieval unit for obtaining an activator for preparing activation of a communication function of the information processing apparatus;
an activator execution unit for executing the activator obtained by the activator retrieval unit;
an activation information retrieval unit for obtaining activation information representing a communication function allowed to be activated in the information processing apparatus in accordance with the activator execution unit executes the activator;
a driver retrieval unit for obtaining a driver for activating the communication function of the information processing apparatus;
a driver execution unit for executing the driver obtained by the driver retrieval unit; and
an activation unit for activating the communication function allowed to be activated in the information processing apparatus indicated by the activation information in accordance with the driver execution unit executes the driver.

2. The information processing apparatus according to claim 1,
wherein the activation information is an activation key.

3. The information processing apparatus according claim 1,
wherein the activator retrieval unit obtains the activator when a password is authenticated.

4. The information processing apparatus according claim 1,
wherein activation unit activates the communication function when a one time password is authenticated.

5. The information processing apparatus according to claim 2, further comprising:
a setting unit for setting the activation key to a storage unit,
wherein the activation unit activates the communication function, allowed to be activated in the information processing apparatus, indicated by the activation key set in the storage unit.

6. The information processing apparatus according to claim 2, further comprising:
a detection unit for detecting connection of a communication device to the information processing apparatus; and
a communication device information retrieval unit, wherein when the detection unit detects connection of the communication device to the information processing apparatus, the communication device information retrieval unit obtains information about the communication device held in a storage unit of the communication device,
wherein the activator retrieval unit obtains the activator for preparing activation of the communication function of the communication standard of the communication device in the information processing apparatus, on the basis of the information about the communication device obtained by the communication device information retrieval unit.

7. The information processing apparatus according to claim 6, further comprising:
a communication standard determination unit for determining the communication standard of the communication device, on the basis of the information about the communication device obtained by the communication device information retrieval unit;
a communication function activation determination unit for determining whether the communication function of the communication standard of the communication device determined by the communication standard determination unit is activated or not in the information processing apparatus; and
a transmission unit, wherein when the communication function of the communication standard of the communication device is determined not to be activated in the information processing apparatus as a result of the determination made by the communication function activation determination unit, the transmission unit transmits, to a server, activation possibility determination information with which the server determines whether the communication function can be activated or not,
wherein the activator retrieval unit obtains the activator for preparing activation of the communication function of the communication standard of the communication device in the information processing apparatus, which is determined to be obtainable when the server determines that the communication function of the communication standard of the communication device in the information processing apparatus can be activated on the basis of the activation possibility determination information.

8. The information processing apparatus according to claim 6,
wherein the activation possibility determination information includes one time password that is input from a communication medium communicating with the communication device.

9. The information processing apparatus according to claim 2, further comprising:
a setting unit for setting the activation key to a storage unit;
a reference unit for looking up the storage unit when the driver execution unit executes the driver;
a setting determination unit for determining whether the activation key is set to the storage unit or not as a result of the look-up by the reference unit; and
a validity determination unit, wherein when the activation key is determined to be set to the storage unit as a result of the determination made by the setting determination unit, the validity determination unit determines whether the activation key set in the storage unit is valid or not,
wherein when the activation key set in the storage unit is determined to be valid as a result of the determination made by the validity determination unit, the activation unit activates the communication function, allowed to be activated in the information processing apparatus, indicated by the activation key set in the storage unit.

10. The information processing apparatus according to claim 9,
wherein the validity determination unit determines whether the activation key is valid or not on the basis of a one time password.

11. The information processing apparatus according to claim 7,
wherein the transmission unit transmits, to the server, the activation possibility determination information attached with application unique information of application desired to be used by a user in the information processing apparatus, and
the activator retrieval unit further obtains an activator for activating a function of the application from the server.

12. The information processing apparatus according to claim 7,
wherein the transmission unit transmits, to the server, the activation possibility determination information attached with unique information of a card scanned over the communication device by a user, and
the activator retrieval unit further obtains an activator for activating the communication function in unit of particular card from the server.

13. The information processing apparatus according to claim 7,
wherein the transmission unit transmits, to the server, the activation possibility determination information attached with information about an individual identifier of the communication device, and
the activator retrieval unit further obtains an activator for activating the communication function in unit of destination and individual product of particular communication device from the server.

14. The information processing apparatus according to claim 7,
wherein the transmission unit transmits, to the server, the activation possibility determination information attached with time and date information, and
the activator retrieval unit further obtains an activator for activating the communication function in unit of lot of particular communication device from the server.

15. The information processing apparatus according to claim 7,
wherein the transmission unit transmits, to the server, the activation possibility determination information attached with information about I/F and information about internal/external type, and
the activator retrieval unit further obtains an activator for activating the communication function in unit of I/F and type of particular communication device from the server.

16. The information processing apparatus according to claim 7,
wherein the transmission unit transmits, to the server, the activation possibility determination information attached with information about vendor ID and product ID, and
the activator retrieval unit further obtains an activator for activating the communication function in unit of product of particular communication device from the server.

17. The information processing apparatus according to claim 3,
wherein the password is a one time password.

18. An information processing method comprising:
obtaining an activator for preparing activation of a communication function of an information processing apparatus;
executing the activator obtained by in the activator retrieval step;
obtaining an activation key representing a communication function allowed to be activated in the information processing apparatus in accordance with the activator is executed in the activator execution step;
obtaining a driver for activating the communication function of the information processing apparatus;
executing the driver obtained in the driver retrieval step; and
activating the communication function, allowed to be activated in the information processing apparatus, indicated by the activation key in accordance with the driver is executed in the driver execution step.

19. A program for causing a computer to function as:
an activator retrieval unit for obtaining an activator for preparing activation of a communication function of an information processing apparatus;
an activator execution unit for executing the activator obtained by the activator retrieval unit;
an activation key retrieval unit for obtaining an activation key representing a communication function allowed to be activated in the information processing apparatus in accordance with the activator execution unit executes the activator;
a driver retrieval unit for obtaining a driver for activating the communication function of the information processing apparatus;
a driver execution unit for executing the driver obtained by the driver retrieval unit; and
an activation unit for activating the communication function, allowed to be activated in the information processing apparatus, indicated by the activation key in accordance with the driver execution unit executes the driver.
